(19) United States
(12) Patent Application Publication
(10) Pub. No.: US 2025/0121447 A1
(43) Pub. Date: Apr. 17, 2025

(54) SYSTEMS AND METHODS FOR AUTONOMOUSLY WELDING INNER SURFACES OF PIPING OR TUBING

(71) Applicant: Novarc Technologies Inc., North Vancouver (CA)

(72) Inventors: Abdolreza ABDOLLAHI, North Vancouver (CA); Soroush KARIMZADEH, North Vancouver (CA); Len ZAPALOWSKI, North Vancouver (CA)

(21) Appl. No.: 18/415,269

(22) PCT Filed: Jul. 19, 2022
(86) PCT No.: PCT/CA2022/051117

§ 371 Date: Jan. 17, 2024

Related U.S. Application Data
(60) Provisional application No. 63/203,388, filed on Jul. 20, 2021.
(60) Provisional application No. 63/362,037, filed on Mar. 28, 2022.

(51) Int. Cl. B23K 9/028; B23K 9/095; B23K 37/02; B25J 5/00

(52) U.S. Cl. CPC B23K 9/028; B23K 9/095; B23K 37/02; B25J 5/00

(57) ABSTRACT

A system for autonomously welding piping or tubing from the inside comprising: an autonomous guided vehicle configured to travel within a pipe or tube; one or more robotic welders mounted on the autonomous guided vehicle, each robotic welder having a welding torch and a camera oriented to capture welding image data mounted thereon, each robotic welder configured to weld a portion of an internal circumference of a seam between adjacent segments of the pipe or tube; a welding power supply, a wire drum, a gas cylinder, and a welding controller connected to each robotic welding arm and mounted on the autonomous guided vehicle; and, a system controller mounted on the autonomous guided vehicle, the system controller operatively connected to control each of the one or more robotic welders and associated welding power supply, wire drum, gas cylinder, and welding controller.

### CROSS-REFERENCE TO RELATED APPLICATIONS

This patent application claims priority to U.S. Provisional Patent Application No. 63/203,388 filed on Jul. 20, 2021 and U.S. Provisional Patent Application No. 63/362,037 filed on Mar. 28, 2022. Both U.S. Provisional Patent Application No. 63/203,388 and U.S. Provisional Patent Application No. 63/362,037 are hereby incorporated herein by reference in their entirety.

### TECHNICAL FIELD

The present disclosure relates to robotic welding systems. Particular embodiments relate to robotic systems and related methods for autonomously welding junctions between sections of pipes or tubes from the inside.

### BACKGROUND

There are numerous situations where pipes or tubes need to be welded from the inside to ensure a proper seal between pipe segments. For example, several current proposals for high-speed transportation of goods and people in tubes (sometimes referred to as a Hyperloop™) call for sealed steel tubes, sometimes located underground, held at low pressure, through which pods can be transported (typically on one or more magnetic levitation of “maglev” rails). Other applications where large pipes or tubes need to be welded include water, sewage, or other types of pipes, wind turbine towers, or other tubular structures.

Examples of previously proposed robotic systems for welding pipes from the inside include CN110508984, KR101108933B1, KR100490228, and JPH07284949A.

The inventors have determined a need for improved systems and methods for autonomously welding inner surfaces of piping or tubing.

### SUMMARY

One aspect of the present disclosure provides a system for autonomously welding piping or tubing from the inside. The system comprises: an autonomous guided vehicle configured to travel within a pipe or tube; one or more robotic welding arms mounted on the autonomous guided vehicle, each robotic welding arm having a welding torch and a camera oriented to capture welding image data mounted thereon, each robotic welding arm configured to weld a portion of an internal circumference of a seam between adjacent segments of the pipe or tube; a welding power supply, a wire drum, a gas cylinder, and a welding controller connected to each robotic welding arm and mounted on the autonomous guided vehicle; and, a system controller mounted on the autonomous guided vehicle, the system controller operatively connected to control each of the one or more robotic welding arms and associated welding power supply, wire drum, gas cylinder, and welding controller.

Another aspect of the present disclosure provides a system for autonomously welding piping or tubing from the inside comprising an autonomous guided vehicle configured to travel within a pipe or tube, a plurality of robotic welders mounted on the autonomous guided vehicle, each robotic welder having a welding torch and a camera oriented to capture welding image data mounted thereon, each robotic welder configured to weld a portion of an internal circumference of a seam between adjacent segments of the pipe or tube, a welding power source, a wire drum, a gas cylinder, and a welding controller connected to each robotic welder and mounted on the autonomous guided vehicle, and a system controller mounted on the autonomous guided vehicle, the system controller operatively connected to control each of the one or more robotic welders and associated welding power source, wire drum, gas cylinder, and welding controller.

In some embodiments the plurality of robotic welders comprise two seven-axis robotic welders, each seven-axis robotic welder comprising a six-axis welding arm mounted on a linear actuator mounted on a forward portion of the autonomous guided vehicle.

In some embodiments the plurality of robotic welders comprise two to four orbital welding heads, each orbital welding head mounted on a robotic crawler configured to travel around a track mounted on a forward portion of the autonomous guided vehicle. An extension may be connected between each orbital welding head and associated robotic crawler to increase the distance from the orbital welding head and the track, wherein a length of the extensions is selected based on an inner diameter of the pipe or tube.

In some embodiments the plurality of robotic welders comprise two to four six-axis welding arms, each six-axis welding arm mounted on a robotic crawler configured to travel around a track mounted on the autonomous guided vehicle.

In some embodiments the autonomous guided vehicle comprises a platform having a welding module connector mounted on a forward end thereof, and the plurality of robotic welders are mounted on the welding module connector.

In some embodiments the autonomous guided vehicle comprises one or more sensors or cameras mounted on a bottom portion of a forward end of the autonomous guided vehicle for detecting positions of seams between adjacent segments of the pipe or tube.

Further aspects of the present disclosure and details of example embodiments are set forth below.

### DRAWINGS

The following figures set forth embodiments in which like reference numerals denote like parts. Embodiments are illustrated by way of example and not by way of limitation in the accompanying figures.

FIG. 1 shows an example robotic welding system with two welding arms mounted on an autonomous guided vehicle for autonomously welding inner surfaces of piping or tubing according to one embodiment of the present disclosure.

FIG. 2 schematically illustrates components of an example control system for the robotic welding system of FIG. 1.

FIG. 3 is a flowchart showing steps of an example method for controlling the robotic welding system of FIG. 1.

FIG. 4 shows an example robotic welding system with four welding arms mounted on an autonomous guided vehicle for autonomously welding inner surfaces of piping or tubing according to one embodiment of the present disclosure.

FIG. 5 shows an example robotic welding system with three arms mounted on an autonomous guided vehicle for autonomously welding inner surfaces of piping or tubing according to one embodiment of the present disclosure.

FIG. 6 shows an example robotic welding system with two welding arms mounted on each of two autonomous guided vehicles for autonomously welding inner surfaces of piping or tubing according to one embodiment of the present disclosure.

FIG. 7 shows an example robotic welding system with a single welding arm mounted on an autonomous guided vehicle for autonomously welding inner surfaces of piping or tubing according to one embodiment of the present disclosure.

FIG. 8 shows an example robotic welding system with two seven-axis robotic welders, each comprising a six-axis welding arm mounted on a linear actuator, mounted on an autonomous guided vehicle, for autonomously welding inner surfaces of piping or tubing according to one embodiment of the present disclosure.

FIG. 9 shows an example robotic welding system with four robotic welders, each comprising an orbital welding head mounted on a robotic crawler configured to travel around a track mounted on an autonomous guided vehicle, for autonomously welding inner surfaces of piping or tubing according to one embodiment of the present disclosure.

FIG. 10 shows an example robotic welding system with four robotic welders, each comprising a six-axis welding arm mounted on a robotic crawler configured to travel around a track mounted on an autonomous guided vehicle, for autonomously welding inner surfaces of piping or tubing according to one embodiment of the present disclosure.

FIG. 11 shows a side view of the example robotic welding system of FIG. 9.

FIG. 12 shows a front view of the example robotic welding system of FIG. 10 riding directly on the inner walls of a pipe.

FIG. 13 shows a front view of the example robotic welding system of FIG. 8 riding along rails installed in a pipe.

FIG. 14 shows the example robotic welding system of FIG. 10 riding along rails installed in a pipe and approaching a seam.

### DETAILED DESCRIPTION

The following describes example systems and methods for autonomously welding inner surfaces of piping or tubing wherein one or more robotic welding arms or other robotic welders are mounted on an autonomous guided vehicle (AGV). The AGV is configured to travel through a tube or pipe carrying the robotic welder(s) and automatically stop at each joint or “seam” between adjacent segments. Each robotic welder has a camera associated therewith for capturing images of weld data, and the system comprises a vision system configured to process the image data and autonomously control the weld process using on board processing and artificial intelligence (AI), but can be overwritten by an operator from a remote station.

In some embodiments, the robotic welder(s) and the AGV are compliant with the ISO 15066:2016 standard for collaborative robots, such that the system is safe to operate in areas where humans may occasionally be present. For example, in some embodiments the system may comprise LIDAR and/or other sensors for detecting the approach of any humans.

In some embodiments, each robotic welding arm is configured to automatically adjust welding variables as disclosed in U.S. provisional patent application No. 63/127,137 and International patent application No. PCT/CA2021/051822, which are hereby incorporated by reference herein. In some embodiments, each robotic welder comprises a six-axis robotic arm (i.e. an arm with six degrees of freedom), but the robotic welders may be differently configured in other embodiments. For example, as described further below, in some embodiments the robotic welders comprise: two seven-axis robots, each comprising a six-axis welding arm mounted on a linear actuator mounted on the AGV; a plurality of orbital welding heads mounted on robotic crawlers configured to travel around a track mounted on the AGV; or a plurality of six-axis welding arms mounted on robotic crawlers configured to travel around a track mounted on the AGV. Other configurations of the robotic welders are also possible.

Some embodiments utilize either existing (“off-the-shelf”) six-axis arc welding robots or other types of robotic welders, but equipped with cameras and vision systems according to the present disclosure, or custom-designed robotic welders, which are operatively coupled to a system controller mounted on the AGV to autonomously move through a tube and automatically weld each seam between segments, while capturing image data of the welds for monitoring and adjusting welding variables in real time, as well as storing image data of the welds for reporting and quality control. For example, in some embodiments, the system can operate in either enterprise mode where it is connected to an external computer network, or in disconnected mode. The system comprises an on-board database of weld data, and all on-board processing capabilities for independent operation and Al control of all welds without requiring connection to an external network. In disconnected mode the system persistently stores weld data, images and videos locally, and on reconnection to an enterprise network these weld logs can be synchronized to a master weld data repository for quality control and audits.

Some embodiments provide a plurality (e.g. 2-4) of robotic welders mounted on an AGV, with the robots configured to each autonomously weld a portion (e.g. 180 degrees in embodiments with two robotic welders; 120 degrees in embodiments with three robotic welders; 90 degrees in embodiments with four robotic welders) of the full circumference of a seam between adjacent segments simultaneously, such that the time required to weld each seam is reduced accordingly (e.g. by a factor of two, three or four).

All necessary welding equipment (e.g., welding wire drum(s), gas cylinder(s), welding power source(s)) is also mounted on the AGV, and the AGV is tethered to a main power station by cables for powering the AGV itself, and for delivering the large amounts of power required for welding. In some embodiments, the welding robots are configured to use gas metal arc welding (GMAW) or metal cored arc welding (MCAW) single or twin wire weld processes.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

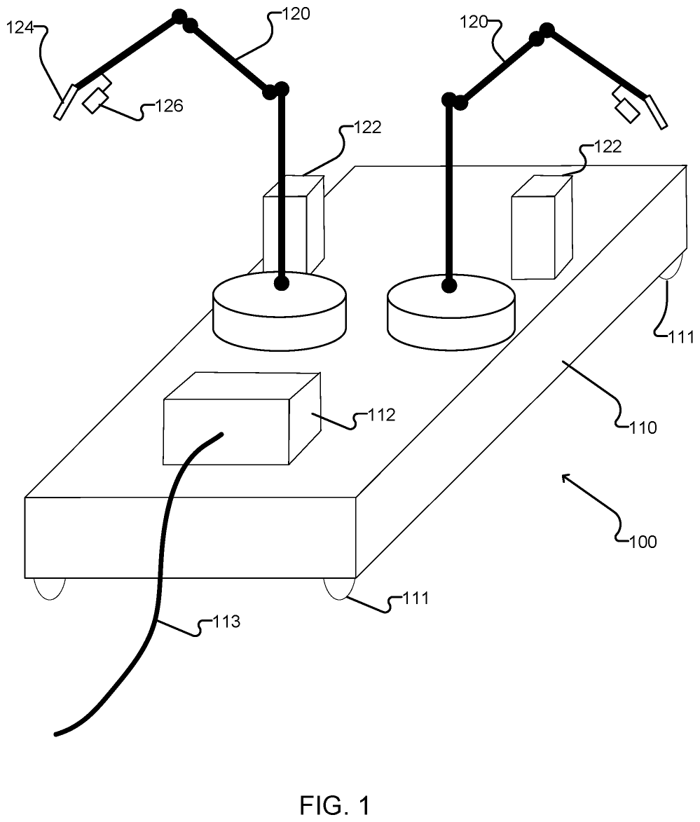

FIG. 1 shows an example robotic welding system 100 according to one embodiment of the present disclosure. The system 100 comprises an autonomous guided vehicle (AGV) 110 with two robotic welding arms 120 mounted thereon. In the illustrated embodiment, the AGV 110 comprises wheels 111 configured to run along one or more rails (not shown) that run through a tube, such as for example, maglev rails or other types of rails, and are elevated from the bottom of the tube, but in other embodiments the AGV could be differently configured depending on the existing infrastructure in the tube. For example, the AGV 110 could have a different shape depending on the type of rail(s), could be configured to be suspended from one or more overhead rails, or could be configured to run directly along the bottom of the tube. Similarly, the robotic welding arms 120 are configured and oriented to take into account both the size of the tube or pipe and any existing tube infrastructure. In the illustrated example shown in FIG. 1, the system 100 comprises two robotic welding arms 120, each of which is responsible for welding an arcuate portion of 180 degrees of the internal circumference of a seam between two adjacent segments of the tube.

A system controller 112 is mounted on the AGV 110, and is operably connected to a welding controller 122 for each robotic welding arm 120. Each robotic welding arm has a welding torch 124 mounted at the end thereof which is controllable to execute a welding pattern under control of the welding controller 122, and a camera 126 positioned to capture welding image data. A welding power source, wire drum and gas cylinder (not shown) connected to each robotic welding arm 120 are also mounted on the AGV, and operably connected to be controlled by the associated welding controller 122 under overall direction of the system controller 112.

The AGV 110 is connected to a main power station by a tether 113 comprising one or more power cables. In the illustrated example, the tether 113 is connected to a power supply module of the system controller 112, which provides power to the robotic welding arms 120 and associated welding controllers 122 and welding power sources. In other embodiments, the tether 113 may comprise cables separately connected to the AGV 110, arms 120, and/or associated welding controllers 122 and/or welding power sources.

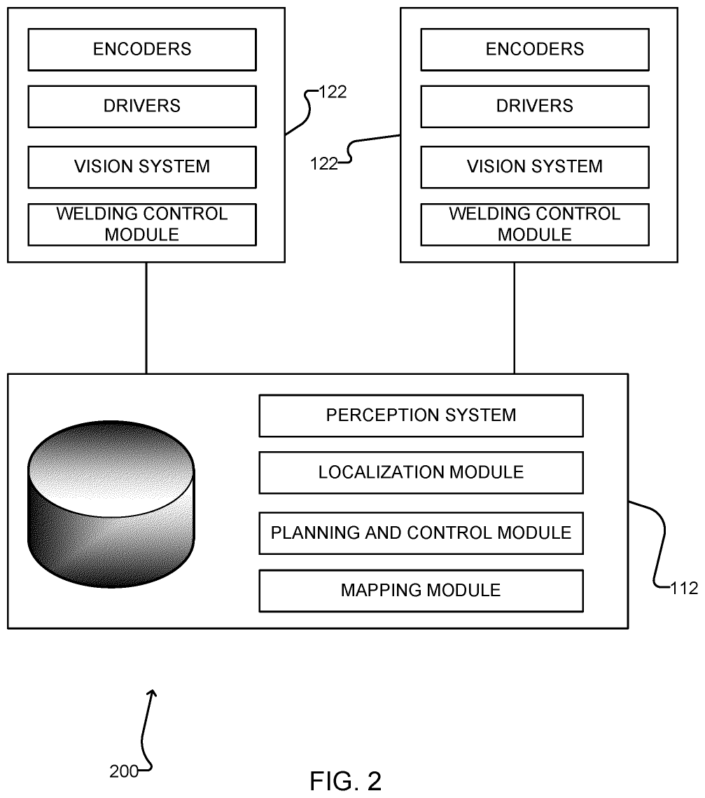

FIG. 2 schematically illustrates components of an example control system 200 for the robotic welding system of FIG. 1. The system controller 112 comprises a perception system comprising one or more sensors configured to receive real time inputs from the surroundings of the AGV, a localization module, a planning and control module, and a mapping module, which exchange information in real time to coordinate the motion of the AGV and reconcile its position within a tube being welded. The system controller 112 also comprises an on-board database of welding data. The planning and control module controls the motion of the AGV, directs operation of the welding controllers 122, and interfaces with the on-board database. Each welding controller 122 comprises encoders (for example high bandwidth encoders) for determining the position of the actuators of the associated robotic welding arm, drivers for powering the actuators, a vision system for capturing and processing welding image data, and a welding control module for controlling welding operations based on feedback from the vision system and other parameters. The welding control module is configured to compensate for any backlash in motions of the welding arm, and any vibrations, and also for temperature and humidity variations. For example, in some embodiments the system 100 is configured to operate in temperatures ranging from 5 to 50 degrees Celsius, and the welding control module is configured to automatically compensate for expansion and contraction of components due to temperature. In some embodiments, embodiments the system 100 is configured to operate in temperatures ranging from −20 to 60 degrees Celsius.

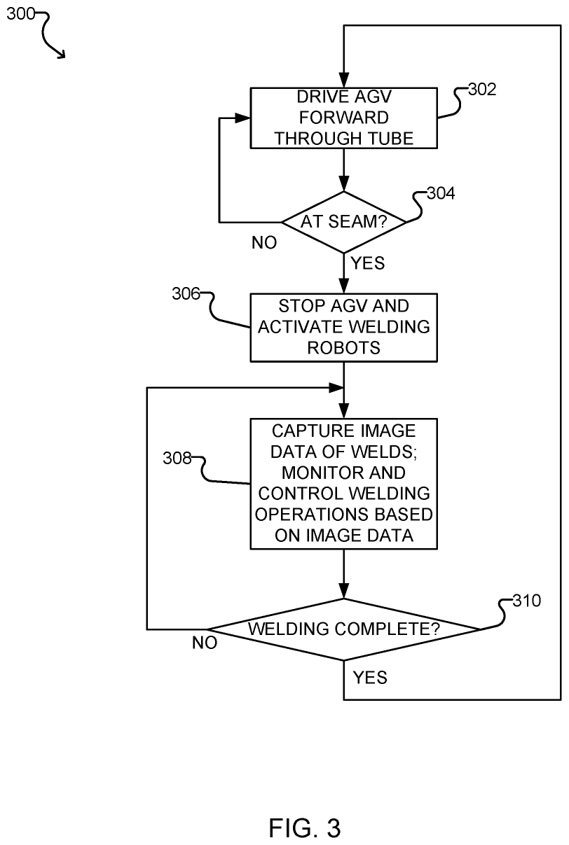

FIG. 3 is a flowchart showing steps of an example method 300 for controlling the robotic welding system of FIG. 1. At block 302 the system controller drives the AGV forward through the tube, trailing the tether behind it. In some embodiments, the system is configured to retract all of the robotic welding arms, or to more the robotic welding arms to predetermined positions, while the AGV is moving, in order to avoid contacting any existing infrastructure within the tube. While the AGV is moving, the system controller monitors the position of the AGV to determine if the AGV is at a seam (block 304 YES output), then at block 306 the system controller stops the AGV and activates the robotic welding arms to perform a welding operation under control of the welding controllers. During the welding operations, at block 308, the cameras capture welding image data, and the welding controllers monitor and control welding operations based on the captured image data to ensure the welding torches are following the seam and effecting a good quality weld. Once the system controller determines that the welding of the seam is complete (block 310 YES output), the method returns to block 302 and the system controller drives the AGV forward until reaching the next seam.

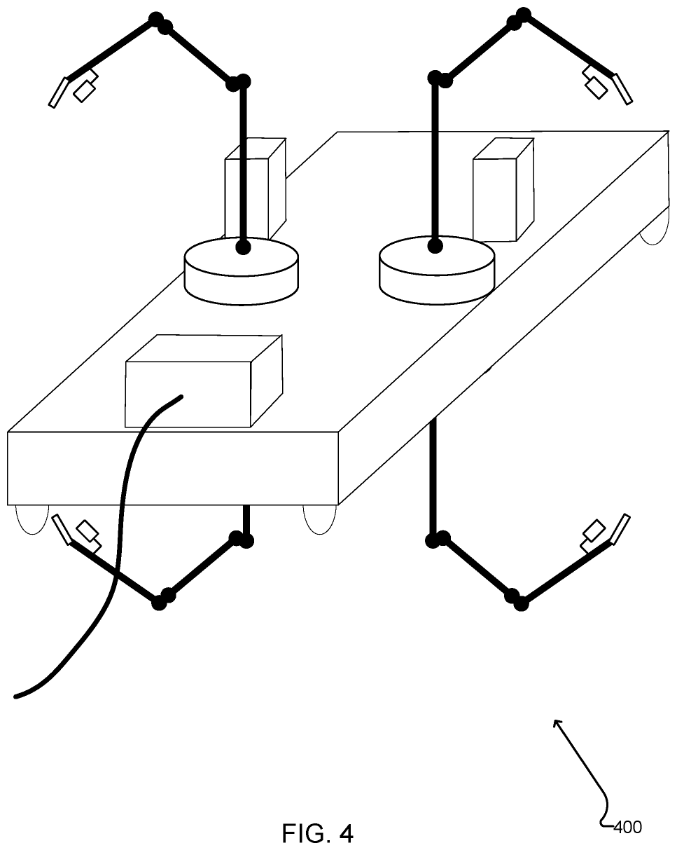

FIGS. 4 to 7 show other examples of robotic welding systems for autonomously welding inner surfaces of piping or tubing. FIG. 4 shows an example robotic welding system 400 with four robotic welding arms mounted on an AGV. The AGV of system 400 is configured to ride on rails, and the robotic welding arms on the underside of the AGV of system 400 are configured to fit around the rails and reach the bottom of the tube below the rails.

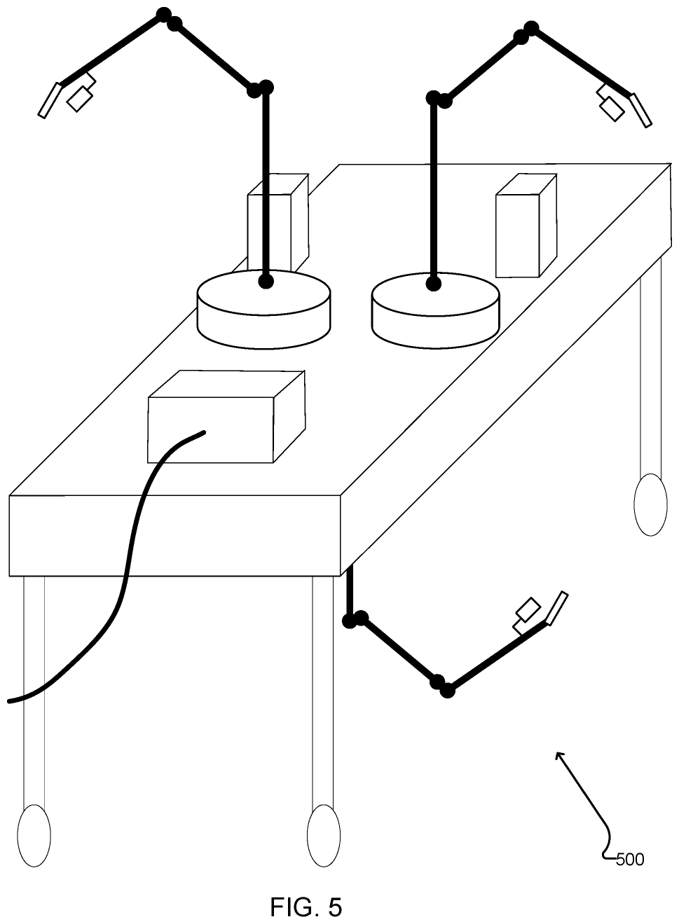

FIG. 5 shows an example robotic welding system 500 with three robotic welding arms mounted on an AGV. The AGV of system 500 is configured to ride directly on the bottom of the tube, and is supported by wheels on legs which provide clearance for the robotic welding arm on the underside of the AGV.

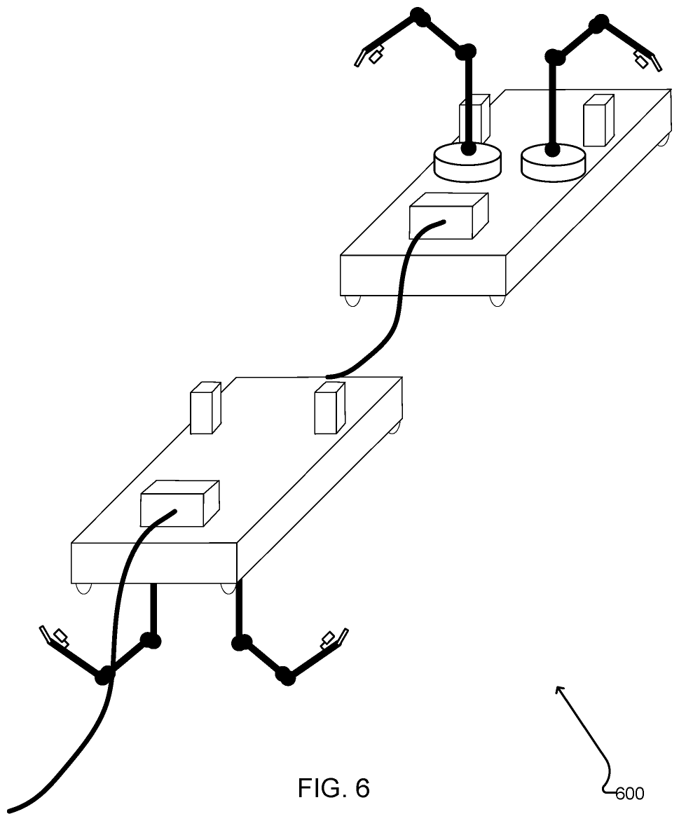

FIG. 6 shows an example robotic welding system with two robotic welding arms mounted on each of a first and second AGV, with the first and second AGVs connected to one another and configure to cooperate to each weld a portion of each seam.

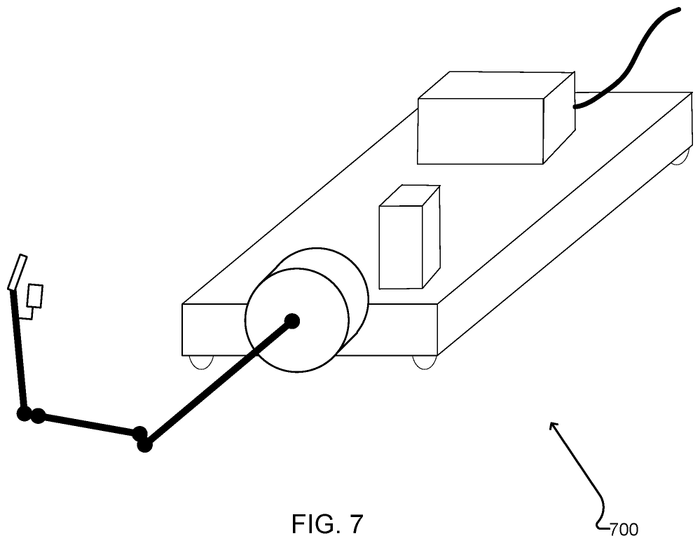

FIG. 7 shows an example robotic welding system with a single robotic welding arm mounted on an AGV for autonomously welding inner surfaces of piping or tubing according to one embodiment of the present disclosure. This example may not provide time savings of multiple robotic welding arms operating simultaneously, but may involve lower capital costs, and may be well suited to some applications.

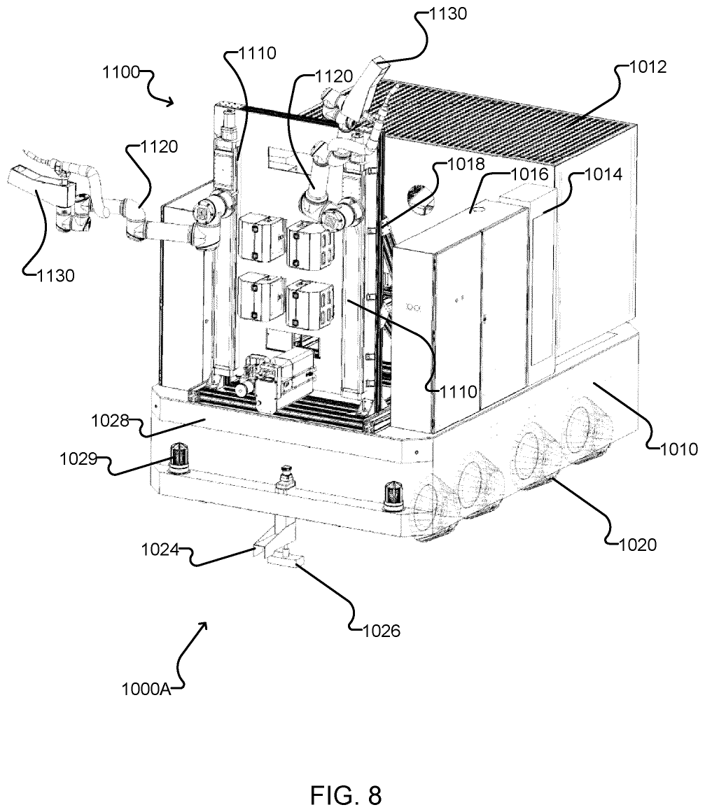

FIGS. 8, 9 and 10 an example robotic welding systems 1000A, 1000B and 1000C for autonomously welding inner surfaces of piping or tubing according to another embodiment of the present disclosure. Each system comprises substantially the same AGV 1010, but has a different welding module 1100/1200/1300 mounted thereon, as described further below. Systems 1000A, 1000B and 1000C can be made to be modular in nature in some embodiments, such that the welding module 1100/1200/1300 can be readily adapted or replace with another module for working in pipes or tubes of different diameters.

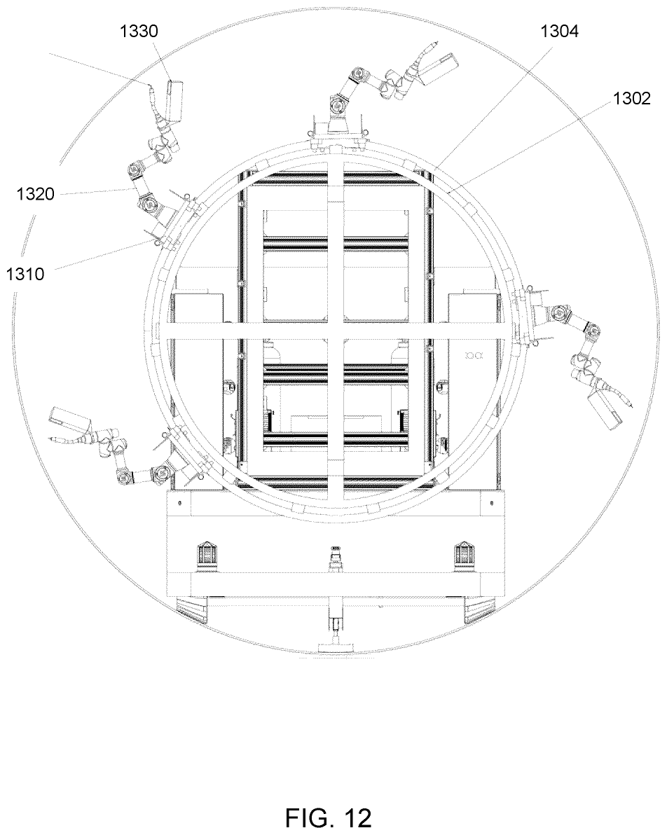

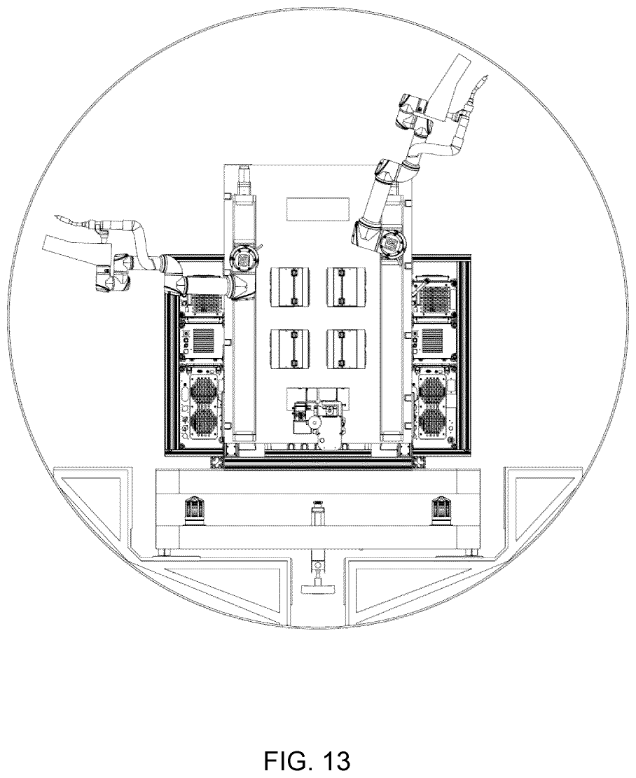

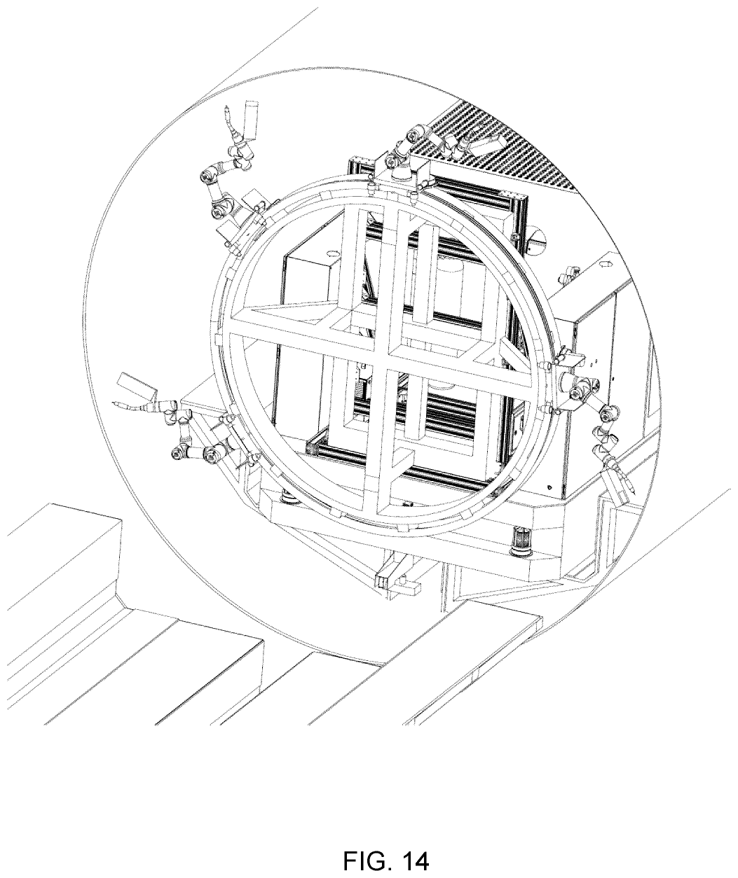

In the illustrated examples, the AGV 1010 comprises a mobile platform having a welding equipment cabinet 1012 mounted on a rear portion thereof, inert gas and control system cabinets 1014 and 1016 mounted on a central potion thereof, and a welding module connector 1018 mounted on a forward portion thereof. The AGV 1010 of FIGS. 8, 9 and 10 comprises non-slip wheels 1020 configured to ride directly on the inner walls of a pipe or tube (as best seen in the front view shown in FIG. 12). In other embodiments the AGV 1010 may have differently configured wheels, for example wheels configured to ride along a railing system installed in a pipe or tube, as discussed below with reference to FIGS. 13 and 14.

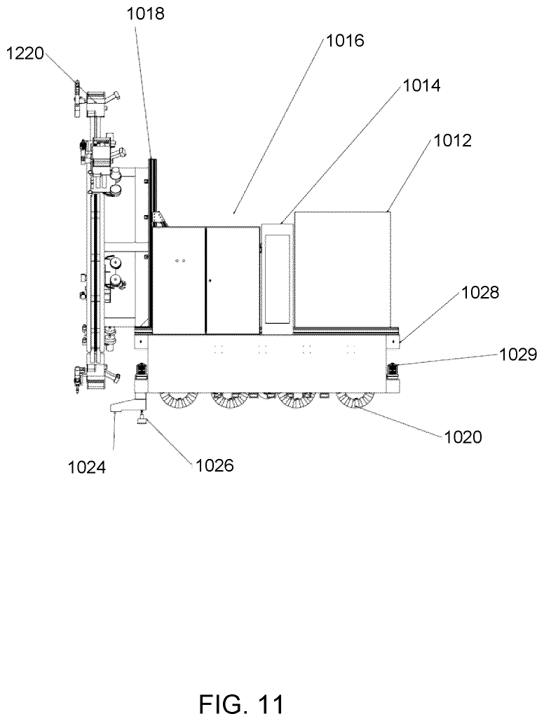

In the illustrated examples, the AGV 1010 is configured to autonomously travel through a pipe or tube and automatically stop at each seam and wait while the welding module 1100/1200/1300 executes a welding operation. The AGV 1010 comprises a seam finding sensor 1024 (e.g. a camera operably connected to an image data processing system) mounted on the bottom of the front end thereof to monitor the floor of the pipe or tube for a seam, and a retractable brake system 1026 that is controlled to engage the floor and hold the AGV 1010 in place when the seam finding sensor 1024 indicates that the welding module 1100/1200/1300 is in the proper position in relation to the seam to initiate a welding operation. The AGV also has ultrasonic obstacle avoidance sensors 1028 and vision and laser navigations sensors 1029 mounted on both the forward and rear ends thereof (as best seen in the side view shown in FIG. 11).

The welding module 1100 of FIG. 8 comprises two seven-axis robotic welders, each comprising a six-axis welding arm 1020 mounted on a linear actuator 1010. A camera 1130 is mounted on each arm 1020 to capture welding image data. In the illustrated example the linear actuators 1010 are in turn mounted on a rigid backing plate that is secured to the welding module connector 1018 of the AGV 1010.

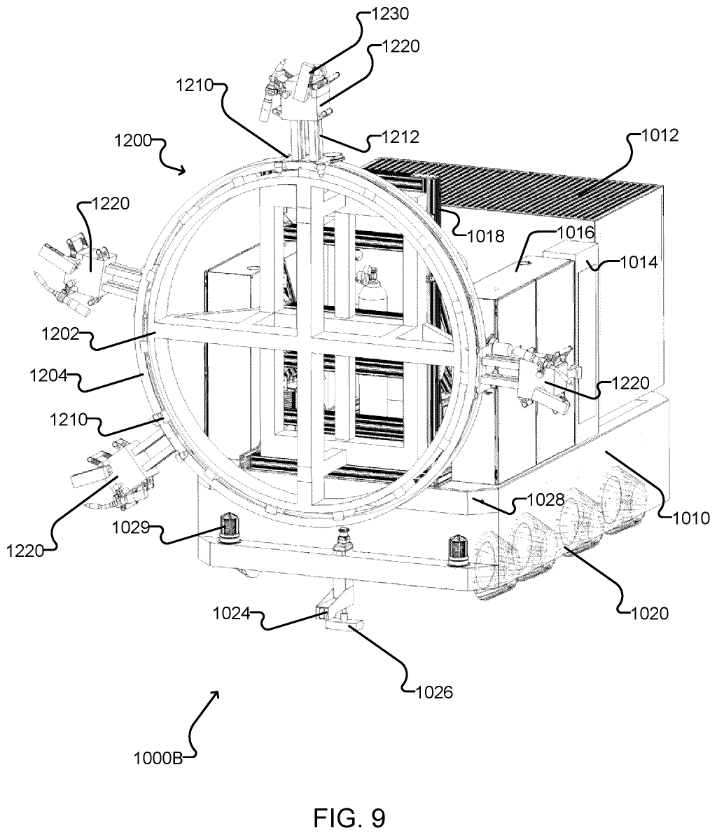

The welding module 1200 of FIG. 9 comprises four robotic welders, each comprising an orbital welding head 1220 mounted on a robotic crawler 1210. The crawlers 1210 are configured to travel around a track 1204, which is installed on a circular frame 1202 that is secured to the welding module connector 1018 of the AGV 1010. A camera 1230 is mounted on each welding head 1220 to capture welding image data. In the illustrated example, an extension 1212 connected between each orbital welding head 1220 and associated robotic crawler 1210 to increase the distance from the orbital welding head 1220 and the track 1204, such that the welding head 1220 can reach the seams, while keeping the diameter of the track 1204 and frame 1202 small enough so as to be able to pass through the pipe or tube without interfering with any internal structures installed therein, such as for example railing systems (when now welding and the AGV 1010 is in motion, the welding heads 1220 can be moved around the track 1204 and positioned as needed to avoid collisions with any internal structures installed within the pipe or tube). In some embodiments, each extension has a fixed length selected based on an inner diameter of the pipe or tube. In some embodiments, each extension has an adjustable length so that the welding module 1200 can be used for welding pipes or tubes with different internal diameters.

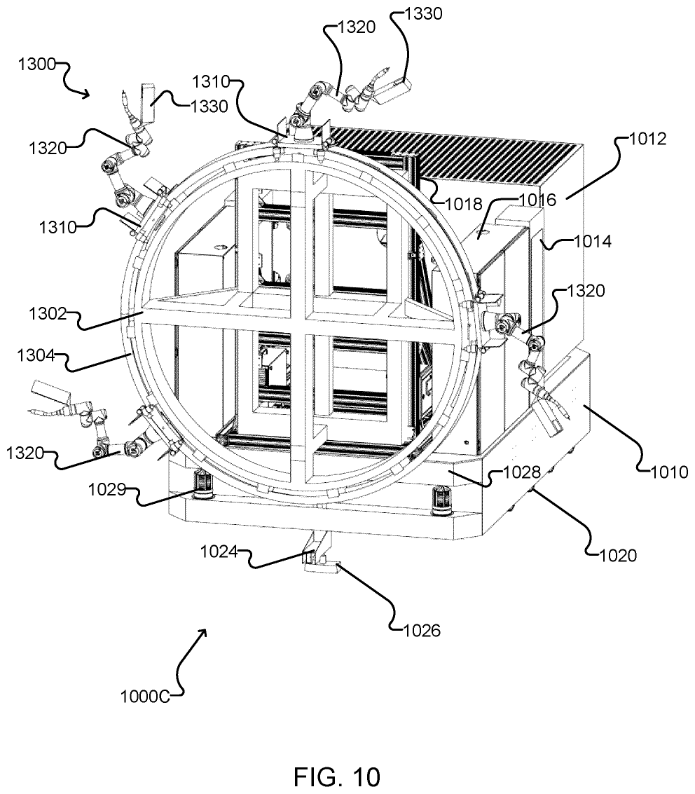

The welding module 1300 of FIG. 10 comprises four robotic welders, each comprising a six-axis welding arm 1320 mounted on a robotic crawler 1310. As in the FIG. 9 example, the crawlers 1310 are configured to travel around a track 1304, which is installed on a circular frame 1302 that is secured to the welding module connector 1018 of the AGV 1010. A camera 1330 is mounted on each arm 1320 to capture welding image data.

Although four robotic welders are shown in FIGS. 9 and 10, it is to be understood that the welding modules 1200/1300 could have only two or three robotic welders. One advantage of systems with two robotic welders is that each robotic welder may be controlled to execute substantially the same welding program, for example by starting from a top point of the seam and welding through an arcuate portion of 180 degrees, but with one robotic welder starting the welding program first and being allowed to complete a portion (e.g. 10 degrees) of the circumferential weld before the other robotic welder starts.

FIG. 14 shows the example robotic welding system 1000C of FIG. 10 riding along rails installed in a pipe and approaching a seam. As one skilled in the art will appreciate, in situations where a railing system has been pre-installed in a pipe or tube to be welded, a gap in the railing system components will be provided at each seam to allow for welding access. In some embodiments, the wheelbase of the AGV and weight distribution of the robotic welding system are configured such that the system can just roll over such gaps. For example, in some embodiments the AGV 1010 comprises 8 wheels on four axles, and the center of gravity of the overall system is positioned between the two central axles, and the spacing between axles is larger than the size of each gap. In some embodiments, the AGV 1010 is provided with an auxiliary set of wheels mounted on an extendible frame that can extend from the front of the AGV such that the auxiliary set of wheels contact the rails on the far side of a gap to provide improved stability when crossing such gaps.

The embodiments of the systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Throughout the foregoing discussion, numerous references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments of the present disclosure may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As will be apparent to those skilled in the art in light of the foregoing disclosure, many alterations and modifications are possible to the methods and systems described herein. While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as may reasonably be inferred by one skilled in the art. The scope of the claims should not be limited by the embodiments set forth in the examples, but should be given the broadest interpretation consistent with the foregoing disclosure.

The present disclosure may be embodied in other specific forms without departing from its spirit or essential characteristics. The described embodiments are to be considered in all respects only as illustrative and not restrictive.

1. A system for autonomously welding piping or tubing from the inside, the system comprising:
a. an autonomous guided vehicle configured to travel within a pipe or tube;
b. a plurality of robotic welders mounted on the autonomous guided vehicle, each robotic welder having a welding torch and a camera oriented to capture welding image data mounted thereon, each robotic welder configured to weld a portion of an internal circumference of a seam between adjacent segments of the pipe or tube;
c. a welding power source, a wire drum, a gas cylinder, and a welding controller connected to each robotic welder and mounted on the autonomous guided vehicle;
d. a system controller mounted on the autonomous guided vehicle, the system controller operatively connected to control each of the one or more robotic welders and associated welding power source, wire drum, gas cylinder, and welding controller.

2. The system of claim 1 wherein the plurality of robotic welders comprise two seven-axis robotic welders, each seven-axis robotic welder comprising a six-axis welding arm mounted on a linear actuator secured to a forward portion of the autonomous guided vehicle.

3. The system of claim 1 wherein the plurality of robotic welders comprise two to four orbital welding heads, each orbital welding head mounted on a robotic crawler configured to travel around a track secured to a forward portion of the autonomous guided vehicle.

4. The system of claim 3 comprising an extension connected between each orbital welding head and associated robotic crawler to increase the distance from the orbital welding head and the track, wherein a length of the extensions is selected based on an inner diameter of the pipe or tube.

5. The system of claim 1 wherein the plurality of robotic welders comprise two to four six-axis welding arms, each six-axis welding arm mounted on a robotic crawler configured to travel around a track secured to the autonomous guided vehicle.

6. The system of claim 1 wherein the autonomous guided vehicle comprises a platform having a welding module connector mounted on a forward end thereof, and the plurality of robotic welders are mounted on the welding module connector.

7. The system of claim 6 wherein the plurality of robotic welders comprise two seven-axis robotic welders, each seven-axis robotic welder comprising a six-axis welding arm mounted on a linear actuator, wherein the linear actuator of each robotic welder is mounted on a rigid backing plate secured to the welding module connector.

8. The system of claim 6 wherein the plurality of robotic welders comprise two to four robotic welders, each robotic welder comprising robotic crawlers configured to travel around a track mounted on a circular frame secured to the welding module connector.

9. The system of claim 8 wherein each robotic welder comprises an orbital welding head mounted on the robotic crawler.

10. The system of claim 8 wherein each robotic welder comprises a six-axis welding arm mounted on the robotic crawler.

11. The system of claim 1 wherein the autonomous guided vehicle comprises one or more sensors or cameras mounted on a bottom portion of a forward end of the autonomous guided vehicle for detecting positions of seams between adjacent segments of the pipe or tube.

12. The system of claim 1 wherein the system controller is configured to store image data for each weld performed by each of the one or more robotic welders.

13. The system of claim 1 wherein the system controller is configured to process image data for each weld performed by each of the one or more robotic welders to determine a classification for each weld, and generate reports comprising the determined classifications.

14. The system of claim 1 wherein the system controller is configured to determine positions of seams between adjacent segments of the pipe or tube based on feedback from one or more sensors or cameras mounted on the autonomous guided vehicle.

15. The system of claim 1 wherein the system controller comprises a map module programmed with locations of seams between adjacent segments of the pipe or tube.

16. The system of claim 1 wherein the autonomous guided vehicle is connected to a main power station by a tether comprising one or more high power cables.

17. The system of claim 1 wherein the autonomous guided vehicle comprises non-slip wheels having angled surfaces configured to ride directly on an inner surface of the pipe or tube.

18. The system of claim 1 wherein the autonomous guided vehicle comprises wheels configured to ride along a railing system installed in the pipe or tube.

19. The system of claim 1 wherein the autonomous guided vehicle comprises a retractable brake system controllable to engage a floor of the pipe or tube.

20. The system of claim 19 wherein the system controller is configured to automatically engage the retractable brake system when the autonomous guided vehicle is in position to initiate a welding operation.

21. A system for autonomously welding piping or tubing from the inside, the system comprising:
a. an autonomous guided vehicle configured to travel within a pipe or tube;
b. one or more robotic welding arms mounted on the autonomous guided vehicle, each robotic welding arm having a welding torch and a camera oriented to capture welding image data mounted thereon, each robotic welding arm configured to weld a portion of an internal circumference of a seam between adjacent segments of the pipe or tube;
c. a welding power source, a wire drum, a gas cylinder, and a welding controller connected to each robotic welding arm and mounted on the autonomous guided vehicle;
d. a system controller mounted on the autonomous guided vehicle, the system controller operatively connected to control each of the one or more six-axis robotic welding arms and associated welding power source, wire drum, gas cylinder, and welding controller.

22. The system of claim 21 wherein the one or more robotic welding arms comprise two robotic arms, each robotic welding arm configured to weld an arcuate portion of 180 degrees of the internal circumference of the seam.

23. The system of claim 21 wherein the one or more robotic welding arms comprise three robotic arms, each robotic welding arm configured to weld an arcuate portion of 120 degrees of the internal circumference of the seam.

24. The system of claim 21 wherein the one or more robotic welding arms comprise four robotic welding arms, each robotic welding arm configured to weld an arcuate portion of 90 degrees of the internal circumference of the seam.

25. The system of claim 22 where the welding arms are configured to weld the arcuate portions simultaneously.

26. The system of claim 21 wherein the automatic guided vehicle comprises a first vehicle and a second vehicle, and wherein the one or more robotic welding arms comprise two robotic welding arms mounted on the first vehicle and two welding arms mounted on the second vehicle, each robotic welding arm configured to weld an arcuate portion of 90 degrees of the internal circumference of the seam.

27. The system of claim 21 wherein the robotic welding arms comprise six-axis robotic welding arms.
